(19) United States
(12) Patent Application Publication
(10) Pub. No.: US 2025/0237488 A1
(43) Pub. Date: Jul. 24, 2025

(54) System comprising a robot and at least one device for the targeted alignment of firing tools

(71) Applicant: ELP GmbH European Logistic Partners, Wuppertal (DE)

(72) Inventors: Morad Sabouri, Wuppertal (DE); Alexander Maus, Wuppertal (DE); Egor Kokyschev, Wuppertal (DE); Bastian Bastian, Wuppertal (DE)

(73) Assignee: ELP GmbH European Logistic Partners, Wuppertal (DE)

(21) Appl. No.: 19/034,418

(22) Filed: Jan. 22, 2025

(30) Foreign Application Priority Data
Jan. 23, 2024 (DE) 102024101919.0

(51) Int. Cl. F42D 5/04; G01S 17/08

(52) U.S. Cl. CPC F42D 5/04; G01S 17/08

(57) ABSTRACT

A system comprising a robot (13) and at least one device (10) for the targeted alignment of firing tools (11) with a firing axis on a target to be hit. At least one carrier system (40) for a firing tool (11) is provided, which comprises a targeting device and has at least one receptacle (41) into which the firing tool (11) can be introduced in certain areas. A plurality of differently shaped firing tools (11) can be introduced into the receptacle (41) and secured there (FIG. 1).

### BACKGROUND

The invention relates to a system comprising a robot and at least one device for the targeted alignment of firing tools according to the preamble of claim 1. Such firing tools or disruptors are used, for example, for defusing dangerous objects, such as bombs, unconventional explosive and incendiary devices or the like. The firing tools are often arranged on remote-controlled manipulators or robots so as not to endanger the operator involved in the defusing. This operator can then carry out the defusing from a distance at a greater distance and preferably behind a safety device. The defusing is often carried out by a so-called disruptor, which comprises an impulse-based firing tool and thus carries out the defusing. However, it may also be necessary to first examine the object to be defused, for example using X-rays. This examination should also preferably be carried out from a distance so as not to endanger operators with the object and/or the X-rays. In the following, this exposure to X-rays or other electromagnetic radiation is also referred to as a “shot” and the device emitting this radiation is referred to as a “firing tool”.

When examining and disarming an object, it is important that the firing tool can be aimed at the target as precisely as possible. There are also firing tools from different manufacturers and with different models. Many firing tools are water-pulse based, which means that water is fired at the target at high pressure. There are firing tools that are recoil-compensated, so that the same pulse is emitted in the opposite direction to the target at the same time, so that the shot is fired without recoil. Other firing tools, however, are not recoil-compensated. Which firing tool is used in the specific situation depends on the respective application. However, it is important that the defusing can be carried out quickly and safely so that as few people as possible are harmed.

EP 2 722 634 A1 describes a method for aiming a disruptor at a target. In this case, a targeting device with a laser beam is aimed at the target. The disruptor is placed between the targeting device and the laser and the laser beam is deflected by mirrors so that the direction of the laser matches the direction of the shot. However, this process is cumbersome and time-consuming.

The distance between the disruptor and the target is also not taken into account when aligning the disruptor with the target. A robot on which the disruptor can be arranged is not described.

Another device is described in U.S. Pat. No. 7,523,582 B1. Here, too, a laser unit with two lasers is positioned between the disruptor and the target in order to achieve the best possible alignment of the disruptor with the target. Two lasers are provided, one of which emits its light at the target and the other laser emits its light in the opposite direction towards the disruptor, where it is reflected by a reflector plate. This aligns the line of fire of the disruptor with the target. However, the reflector plate is not removed before the shot is fired and is therefore destroyed. Here, too, no robot or similar device is described that positions the disruptor.

US 2008/0276473 A1 describes another device for aligning a firing tool with a target. Here, two line lasers are provided, the axes of which are arranged at an angle to each other so that the laser planes intersect. The intersection axis of the laser planes coincides with the firing axis of the firing tool. The distance from the firing tool to the target is determined by measuring the width of the laser planes. However, depending on the visibility conditions and the surface of the target, this can be inaccurate.

In addition, the line lasers must be permanently in operation during target acquisition and alignment in order to measure the distance. This means a high level of radiation emission over the entire duration of target acquisition and thus a high level of radiation exposure and permanent energy consumption. Here, too, it is not described how to position the disruptor using a robot.

Furthermore, US 2012/0180366 A1 describes a targeting device for a disruptor for bomb disposal, in which two line lasers are also arranged at an angle to each other so that the lines intersect. Here, too, the intersection point of the line lasers coincides with the firing axis of the firing tool. In order to determine the distance between the firing tool and the target, a distance measurement using another laser is provided. By determining the distance, it is possible to align the target point and thus also the firing tool with the target. A possibility of bringing the firing tool into the correct position using a robot is not described here.

U.S. Pat. No. 7,523,582 B1 describes a precise targeting system for a laser with a firing tool, a laser and a reflector. The disadvantage here is that the device must first be positioned and aligned near the object to be destroyed or defused and the operator can only then retreat to a safe area to trigger the ignition.

Finally, US 2007/0105070 A1 describes an electromechanical soldier in the form of a robot that is equipped with an interchangeable weapon. The robot is intended for fighting in war and crisis zones but also for police work. The types of weapons that the robot can be equipped with are very different. There are also ways in which the robot can aim the weapons at a target, but these are aimed at human or military targets. Precise or highly precise alignment with a target, as is necessary when defusing a bomb or an unconventional explosive or incendiary device, is not provided here. Nor is it described that the various weapons with which the electromechanical soldier can be equipped can all be easily inserted into a single holder on the soldier. The fact that this cannot be the case is shown by the wide range of possible weapons, from rifles to flamethrowers to grenade launchers, etc.

The object of the invention is therefore to avoid the aforementioned disadvantages and to develop a system comprising a robot and a device for aligning a firing tool, which can be equipped with the most diverse forms of firing tools without major modifications. This object is solved by the characterizing features of claim 1, which have the following particular significance.

### SUMMARY OF THE INVENTION

A carrier system with a holder for the firing tool is provided, the holder being designed in such a way that a large number of differently shaped firing tools with different modes of action can be inserted into the holder and secured there without carrying out lengthy modifications. It is therefore possible for an operator to select the firing tool that is best suited to the specific situation. This makes it possible to quickly select the firing tool that is most suitable for the situation and to arrange it in the carrier system on the robot.

It is particularly easy if one or more sleeves are provided that can be inserted into the holder on the carrier system and into which the firing tool can be inserted. Several of these sleeves can be provided in order to insert very different firing tools into the holder. The sleeves can be made of plastic or metal and can be inexpensive to manufacture and easy to assemble, so that a wide variety of firing tools can be quickly converted. This also compensates for manufacturing tolerances and wear and the firing tool is still securely arranged in the carrier system. For this purpose, the sleeve can have one or more slots at one end along its longitudinal direction. An external thread is also provided, which extends in the area of the slot(s).

The counterpart is a clamping nut that has an internal thread and can be screwed onto the external thread of the sleeve. The external thread and/or the internal thread are conical or otherwise progressively tapered, so that the sleeve contracts more and more when the screw connection between the external and internal thread is made. This can compensate for small differences in the diameter of the shooting tool. The clamping nut can be knurled or its outer circumference can be of a different nature, so that the clamping nut can be assembled and disassembled without tools.

To prevent the sleeve from rotating in the holder when the clamping nut is screwed onto the external thread, the sleeve can have at least one projection and the holder can have at least one recess. The projection then engages in the recess, preventing the sleeve from twisting in the holder. Of course, a kinematic reversal is also possible here, so that the projection is provided on the holder and the recess on the sleeve.

There are preferably various ways of attaching the carrier system to the robot. If the robot has a gripping unit, such as a gripping arm, it can grip one side of the carrier system. The robot particularly preferably also has at least one camera that the operator can use to perceive the robot's surroundings. A camera can be arranged on the gripping unit. Preferably, when the carrier system is gripped by the gripping unit, the camera is neither covered by the gripping unit itself nor by the carrier system. This allows an operator to look directly over the camera in the direction in which the firing tool is aimed. Depending on the firing tool used, the operator can also see the barrel of the firing tool in the camera view.

In a preferred embodiment, two target lasers are provided, which are designed as line lasers and which are arranged so that their projection planes are arranged at an angle other than 180° around the firing axis. The projection planes intersect and form an intersection line that is identical to the firing axis and which forms a target point by projecting the intersection line onto the target to be hit.

Furthermore, a separate distance measuring device can be provided which measures the distance between the firing tool and the target, in particular by using at least one laser. Furthermore, at least one display is provided which shows the measured distance. The distance between the firing tool and the target can be determined using the separate distance measuring device, regardless of the use of the target laser. This enables particularly precise and efficient target detection. In particular, when the beams of the target lasers emit visible light, the intersection point of the two line lasers can be perceived by the human eye. Depending on the angle between the two projection planes of the target lasers, the target is then perceived with a typical “crosshair” or with a cross with other angles.

Particularly preferably, at least one display is provided on which the distance between the firing tool and the target object is indicated. This allows an operator to estimate how far the firing tool is from the target object. The display can be arranged close to the device according to the invention, whereby an operator can either be near the device to read the display or a camera can record the display and send the resulting image to an operator. The usual transmission paths here are conceivable via radio, Bluetooth, mobile communications, WLAN, etc. or also via a cable. In addition, a display can be located at a distance from the device, whereby the measured distance can then be sent directly to an operator via the transmission paths already mentioned and this operator can read the information via a mobile phone, notebook, tablet PC, smartwatch, stationary computer or other devices. This distanced output device can then be used by an operator who is not in the danger zone of the object to be neutralized.

It is particularly preferred if the display of the information is integrated into the output unit of the control device that is used anyway.

It is particularly preferred if the target lasers are initially switched off and only the distance measuring device is active. As soon as the device approaches the target so far that it makes sense to use the firing tool, or at a set point in time when a selected distance range of the distance between the firing tool and the target object is reached, the target lasers are automatically switched on in order to align the firing tool with the target. This avoids unnecessary radiation and saves energy. It is also advantageous if the device sends out an optical and/or acoustic signal when a predetermined distance range is reached. It is then clear to people nearby and also to people at a distance that the distance range has been reached and that a shot could be fired from the firing tool shortly.

It is also advantageous if the target lasers and/or the distance measuring device and/or the entire device can be switched on and/or off remotely. In this case, the device is particularly easy to operate from a distance, so that an operator does not have to enter the danger zone. Of course, it is also possible to switch the target laser and/or the distance measuring device on and off directly on the device.

The distance measuring device can be equipped with a laser to measure the distance to the target. The light reflected from the smooth or rough surface of the target is received by a sensor on the distance measuring device and the distance to the target object is determined from this. The distance from the device to the target can thus be determined relatively accurately, even in unfavorable environmental conditions. Of course, the distance from the device to the target can also be determined using another suitable distance measuring device.

In a special embodiment, the rays emitted by the target lasers are not perceptible to the human eye. The exact determined target position can then be calculated and shown to a user on a display. A “crosshair” or other marking from a computer or similar device can then be displayed here and the determined target can be marked.

In a further preferred embodiment, a light shaft is provided for each of the target lasers, which simulates the fan of beams and encloses them, so that it protects against, for example, entering the danger zone of laser class 3 with the eye. The point of the laser light exit is extended so that the radiation exit is fanned out by the distance so that the emerging line laser only has a strength according to laser class 2. This makes the laser less dangerous for an operator.

Preferably, at least one camera is provided to transmit the target object, the alignment of the device to the target and other details to people standing at a distance so that they can operate the device and, if necessary, make decisions about the correct procedure without putting themselves in danger. The camera can transmit the images in real time to one or more operators or to one or more output devices or displays.

In order to be able to operate the device from a distance, it can be mounted on the robot, for example on a remote-controlled gripper arm or on a similar device. This allows the device to be brought as close to the target object as necessary without an operator also having to enter that area. The camera provided on the robot can serve as the only camera to transmit the target object, the orientation of the device to the target and other details to one or more operators.

For this purpose, a carrying unit can be provided for the device, which is designed in such a way that it does not cover the camera provided on the robot and this can be used for aiming. Of course, it is also possible for the robot to have more than one camera. In particular, an additional PTZ camera can be mounted on the robot to better capture certain details. Such cameras can be swiveled and tilted. The focal length can also be changed to capture special details.

The device can be supplied with energy by the robot or can have its own energy supply. The latter has the advantage that the device can function independently of a robot and does not need to be coupled to the robot energetically, but only mechanically, if this is desired in the specific application.

The firing tool can, as already mentioned, be pulse-based in order to directly defuse an object. However, a firing tool can also be used that emits electromagnetic waves, such as X-rays. Such a firing tool can be used, for example, to first examine an object more closely so that a decision can then be made about the best and most effective defusing method. The device according to the invention can then be used to correctly align the X-rays on the object.

A boundary geometry component can also preferably be provided. This protects the surrounding components and the robot from damage, in particular from damage caused by the use of the firing tool. Even if the robot falls during its movements, the sensitive components, such as the receiver, are protected from damage.

In a preferred embodiment, one or more alignment aids are also present which serve to precisely align the target lasers or their projection planes. These can adjust the target lasers precisely, for example if they have become misaligned, even due to external influences. The alignment aids can be arranged radially around the firing tool and, for example, indicate the perpendicularity of the projected lines.

Another subject of the present invention is a robot with several of the aforementioned devices. This robot should be able to move in different environments in order to bring the devices close to the object to be examined or defused without an operator having to be nearby and thus in the danger zone.

Several different firing tools can also be provided on the robot, whereby the specific firing tool can be selected depending on the distance and/or the nature of the target object. If several firing tools are provided, the defusing of an object can be carried out more quickly and safely. The same carrier system can then be used for each of the firing tools.

It can also preferably be provided to manually switch the targeting device and/or the firing tool and/or the firing tool's ignition unit on or off. This is useful, for example, if the robot first has to be equipped with the firing tool and/or aligned. A misfire can then be avoided, as can contact of the operator with the radiation from the target laser.

Radio, WLAN can be used for communication between the operator and the robot and/or the firing tool's ignition unit and/or the targeting device. Bluetooth, infrared, a cellular network or another wireless data connection may be provided. A single wireless data connection is preferably provided for communication with and/or control of the robot and/or control of the aiming device and/or control of the firing unit of the firing tool. If multiple wireless data connections are used, interference between them may occur. This is avoided by using a single data connection.

Preferably, the firing tool can be detonated remotely. This means that only the robot is near the bomb when it is defused and no operator is present. Usually, there is a receiver on the robot that is responsible for receiving the ignition signal. This signal is then passed on from the receiver to the ignition unit, which is also located on the robot. Cables then go from the ignition unit directly to the firing tool via electrical connectors on the ignition unit. If the firing tool is recoil-compensated, the cables are often torn off by the escaping water jet that compensates for the recoil of the shot. If a non-recoil-compensated firing tool is used, the recoil causes it to fly out of the carrier system holder, tearing the cable with it. In both cases, the cable tears at a random point and can also damage the ignition unit and/or other system components, which then have to be repaired before the system can be used again. To prevent this, the cables in question are arranged from the electrical connection means on the ignition unit to first electrical connection means on the carrier system. These are located on the same side of the robot as the ignition unit, so that they do not run in the path of the recoil water jet in the case of a recoil-compensated firing tool. Within the carrier system, the electrical ignition pulses are passed on to second electrical connection means. These are arranged very close to the firing tool or its electrical connection means. If a non-recoil-compensated firing tool is now used, these last cables will also be torn, but the ignition unit cannot be damaged because it is not directly connected to these cables.

Further advantages and embodiments of the invention can be found in the subclaims, the further description and the drawings.

### DESCRIPTION OF THE DRAWING

The invention is shown in several embodiments in the figures. They show:

FIG. 1: a first system according to the invention with a robot and a carrier system at the back of the robot, in perspective,

FIG. 2: the system from FIG. 1 in top view,

FIG. 3: the carrier system from FIGS. 1 and 2 mounted on the robot in detail,

FIG. 4: the robot from FIGS. 1 to 3 without a firing tool,

FIG. 5: the system according to the invention with a carrier system in the gripping unit of the robot, in perspective,

FIG. 6: the system from FIG. 5 in top view,

FIG. 7: the carrier system from FIGS. 5 and 6 mounted on the robot in detail,

FIG. 8: the carrier system from FIGS. 5 to 7, in side perspective,

FIG. 9: a robot with two devices according to the invention, in perspective,

FIG. 10: an enlargement of a device according to the invention with display, from behind,

FIG. 11: a device according to the invention in a further embodiment on mounted on a robot, perspective from behind,

FIG. 12: the device from FIG. 11, perspective from the front above,

FIG. 13: another embodiment of a device according to the invention mounted on a gripping unit, perspective from behind,

FIG. 14: the device from FIG. 13, perspective from the front,

FIG. 15a: a first embodiment of a sleeve according to the invention, in perspective,

FIG. 15b: a second embodiment of a sleeve according to the invention, in perspective,

FIG. 16: a clamping nut according to the invention, in perspective,

FIG. 17: the sleeve from FIG. 15b and the clamping nut assembled, in longitudinal section,

FIG. 18a: the sleeve from FIG. 15a with recess and clamping nut in exploded view,

FIG. 18b: the sleeve from FIG. 15b with recess and clamping nut in exploded view,

FIG. 19a: the sleeve from FIG. 15a with carrier system and a first firing tool,

FIG. 19b: the sleeve from FIG. 15b with carrier system and a second firing tool,

FIG. 20: the carrier system with firing tool from behind,

FIG. 21: Detail of the robot with ignition unit.

### DETAILED DESCRIPTION

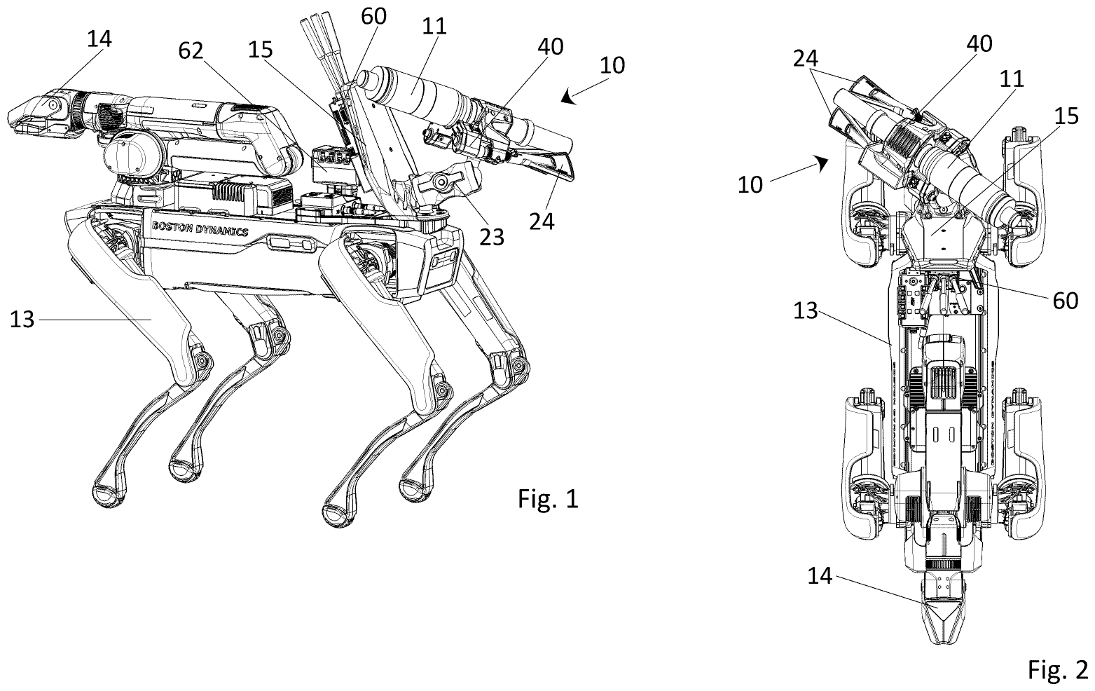

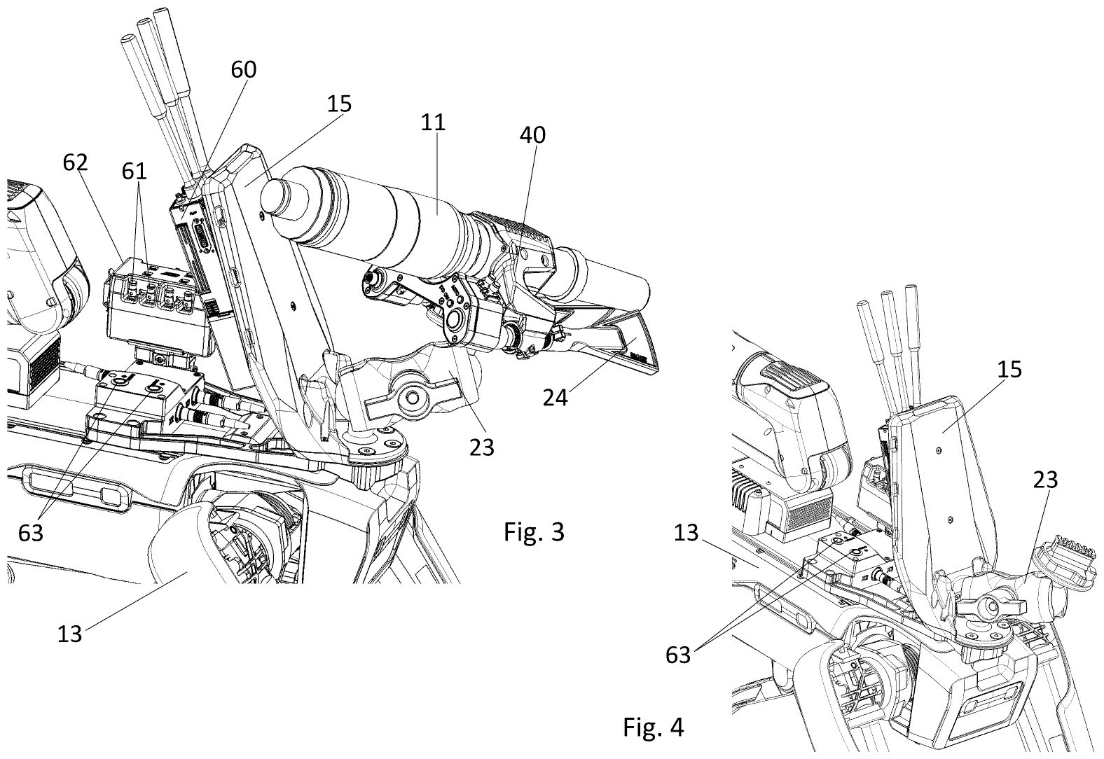

FIGS. 1 to 3 show a system according to the invention with a robot 13 and a device 10. The device 10 comprises a firing tool 11 which is arranged in a holder 41 on a carrier system 40. Two target lasers 20.1, 20.2 are used for the aiming device, which are designed as line lasers and which will be described in more detail later. Each of the target lasers 20.1, 20.2 has a light shaft 24 which is designed approximately fan-shaped. The light shaft 24 is hollow so that the light from the target laser 20.1, 20.2 can be guided through it. The device 10 is arranged in the rear area of the robot 13.

There is an alignment aid 23 which ensures that the carrier system 40 can be aligned in a certain direction, e.g. upwards or downwards. This is also clear from FIG. 4. Furthermore, the limiting geometry component 15 can be seen, which protects the robot 13 and other components from damage, for example when using the firing tool 11. In particular, the receiver 60, which is designed as a radio device here, is protected by the limiting geometry component 15.

Furthermore, the ignition unit 62 can also be seen, which is also protected by the limiting geometry component 15.

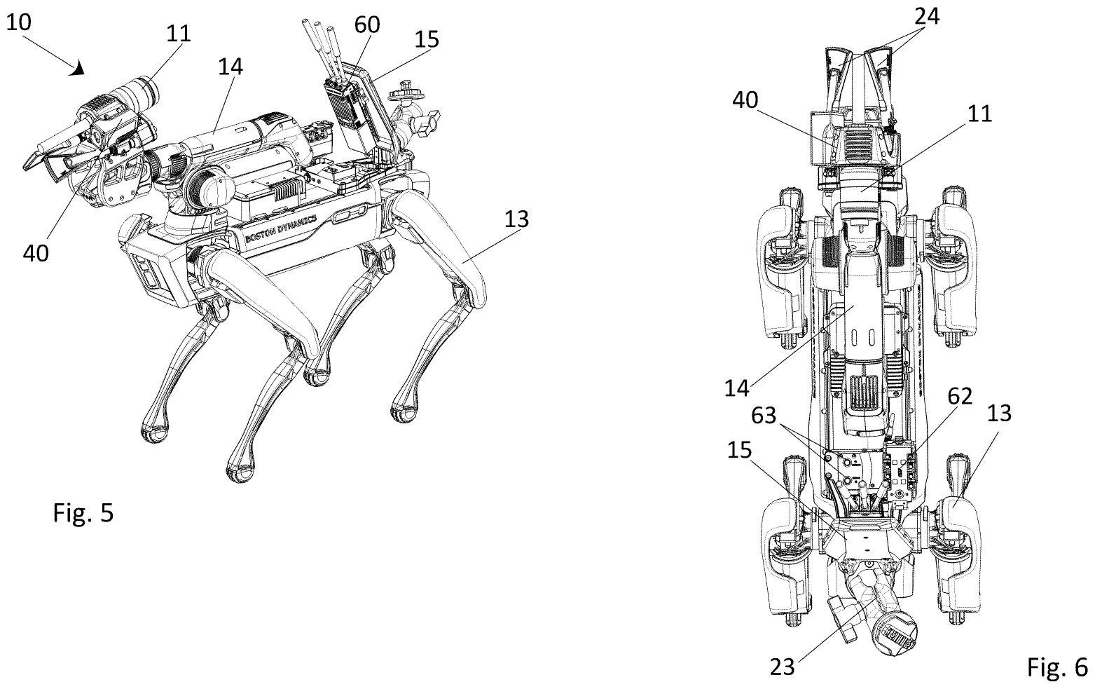

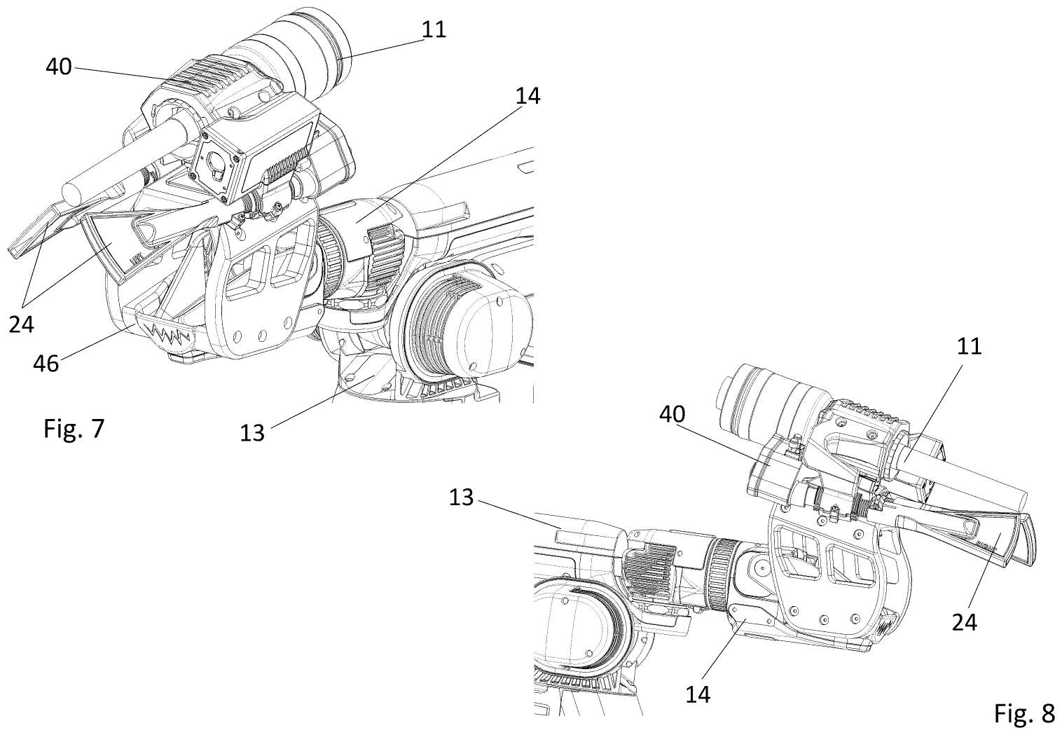

The same robot 13 and the same carrier system 40 can be seen in FIGS. 5 to 8. This time, the carrier system 40 is arranged on the gripping unit 14 of the robot 13, which is designed as a gripping arm. The receiver 60 and the limiting geometry component 15 are arranged at the same location on the robot 13 as in the previous embodiment. The gripping unit 14 holds an area 46 of the carrier system 40 so that the carrier system 40 is arranged firmly on the robot 13. The camera 12 built into the gripping unit 14 is not covered by the carrier system 40 or the gripping unit 14 and can continue to be used by an operator. This is clearly visible in FIGS. 7 and 8. The gripping unit 14, designed as a gripping arm, is very mobile, so that objects located under vehicles or in hollow spaces, for example, can also be defused with the firing tool. In addition, the robot 13 used here is very mobile, which means that it can be used on the one hand in a wide variety of terrain, including impassable terrain, and on the other hand also in buildings, since it can also climb stairs.

Finally, the robot 13 can also perform a variety of movements on the spot, such as stretching, ducking, turning sideways, etc. Together with the gripper arm, many places, including hidden ones, are therefore accessible.

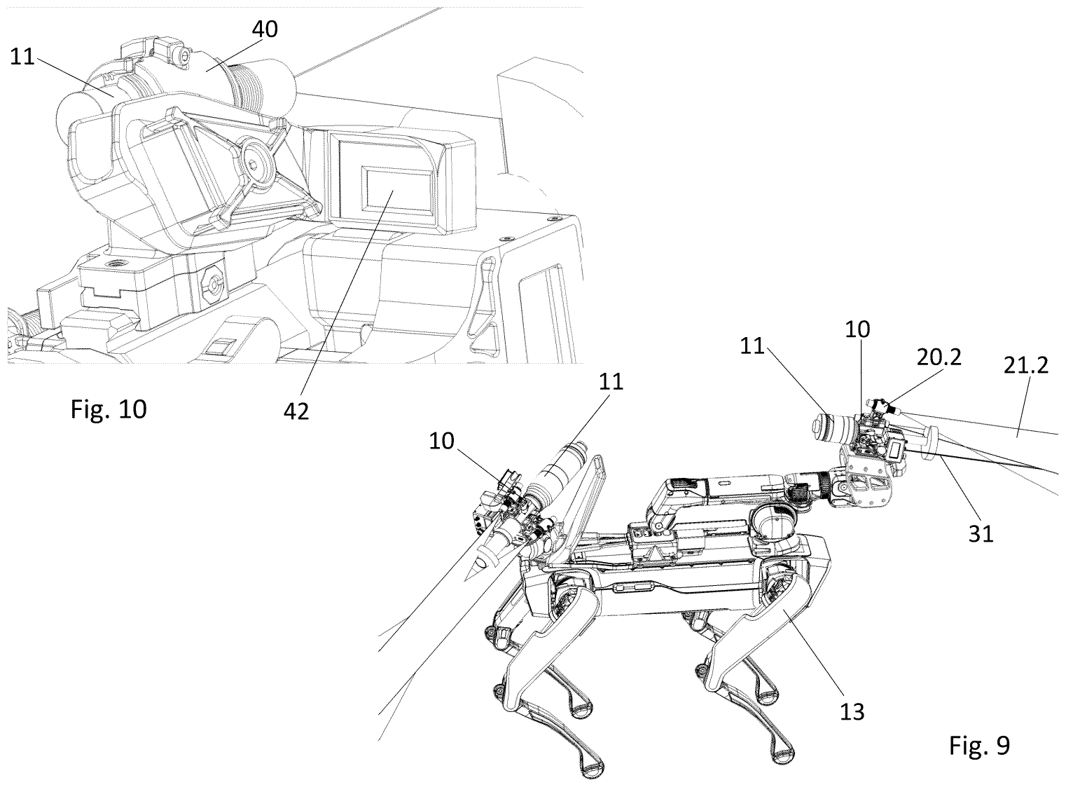

FIG. 9 shows a robot 13 with two devices 10 according to the invention. The devices 10 differ from one another and one or the other device 10 can be used depending on the target object or the position or distance of the target object. Different shooting tools 11 can be inserted into the devices 10. Of course, more than two devices 10 or just one device 10 can be provided on the robot 13. The robot 13 is very versatile and can move the device 10 towards the target object even in difficult terrain. It can also duck and bend and has many degrees of freedom in its movement. However, other types of robots 13 or other transport devices can also be used to move the device 10 to the target object. The display 42 can be seen again in FIG. 10. For this purpose, there is a cover that can protect the display 42 from damage and disturbing light.

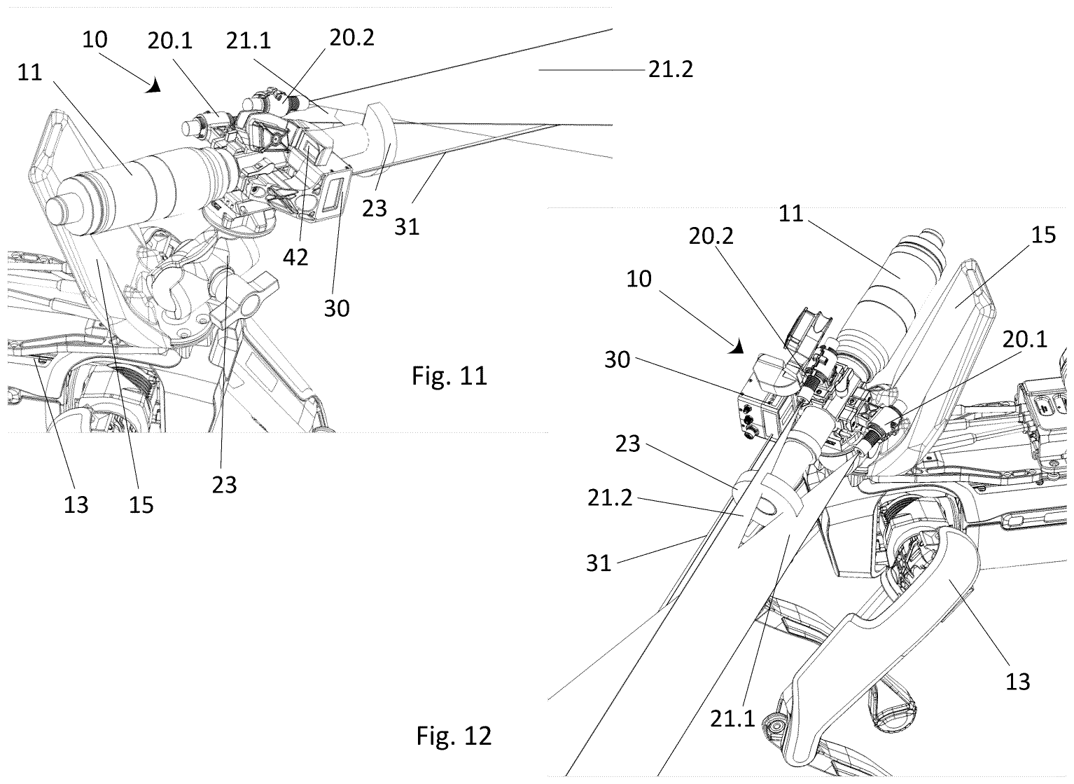

FIG. 11 and FIG. 12 show a device 10 according to the invention, which comprises a carrier system 40 and is mounted on a robot 13 to form a system according to the invention. The firing tool 11 and the two target lasers 20.1 and 20.2, which form the projection planes 21.1 and 21.2, can be seen. The intersection line of the two projection planes 21.1 and 21.2 forms the firing line of the firing tool 11. Furthermore, the distance measuring device 30 can be seen, which measures the distance to the target object using a laser 31. A camera 12 is also arranged in the area of the distance measuring device 30, which records the target area, the target object and/or the surroundings. In the embodiment shown here, the integrated camera 12 of the handle unit 13 is used for this purpose. In FIG. 11, a display 42 can also be seen, which can display data, e.g. on the distance of the target object or other types. Furthermore, the boundary geometry component 15 is provided, which serves to protect the surrounding components and the robot 13 from damage, in particular through the use of the firing tool 11, and to suitably align the device 10.

Furthermore, the alignment aid 23 can be seen, which serves to align the target lasers 20.1 and 20.2 and their projection planes 21.1 and 21.2 to the firing axis. This can also be done if the target lasers 20.1 and 20.2 have been adjusted, for example due to external influences.

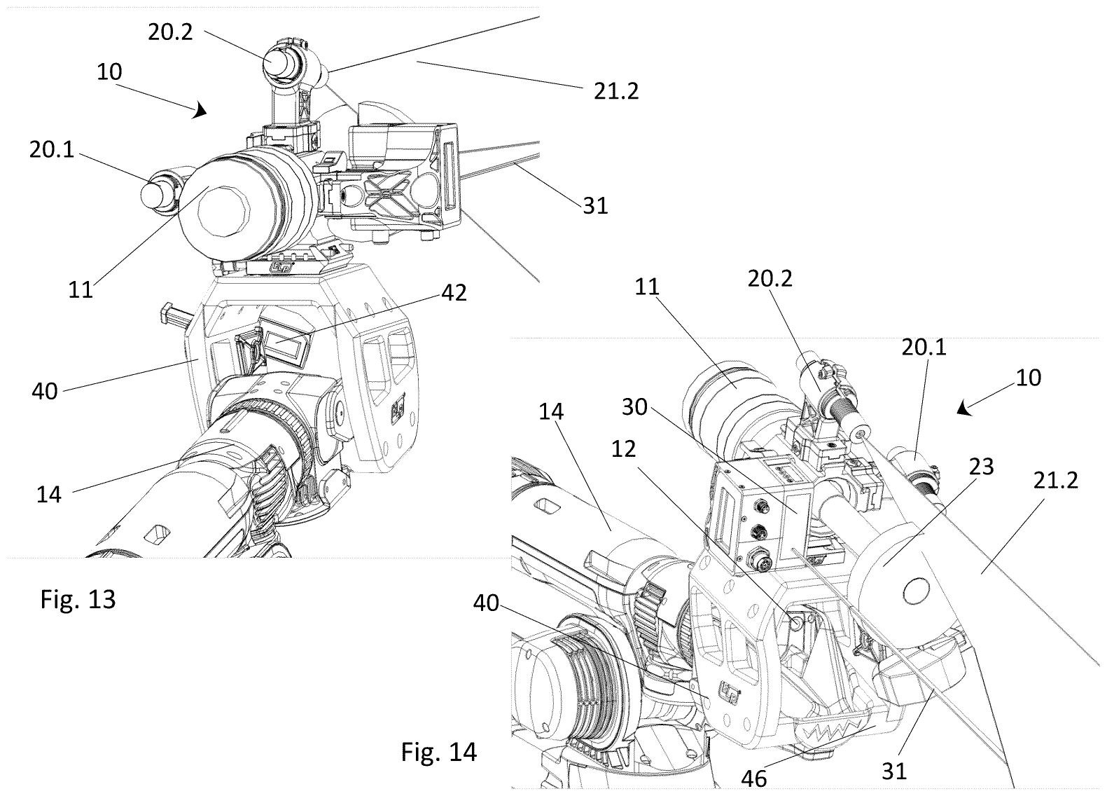

FIGS. 13 and 14 show a further embodiment of the invention. The firing tool 11 shown here is arranged on a carrier system 40. In the embodiment shown here, this is a gripping unit 14 of the robot 13 designed as a gripping arm. Here, too, the two target lasers 20.1 and 20.2 are visible with their projection planes 21.1 and 21.2, the intersection line of which forms the target line of the firing tool 11. Here, too, the distance measuring device 30 and the integrated camera 12 can be seen. The specially designed carrier system 40 enables the integrated camera 12 of the robot 13 to be used to aim at the target to be hit, since it is not covered by the carrier system 40 or by the gripping unit 14 of the robot 13. In this particularly preferred embodiment, the carrier system 40 is adapted to the gripping unit 14 in such a way that the gripping unit 14 encompasses an area 46 of the carrier system 40.

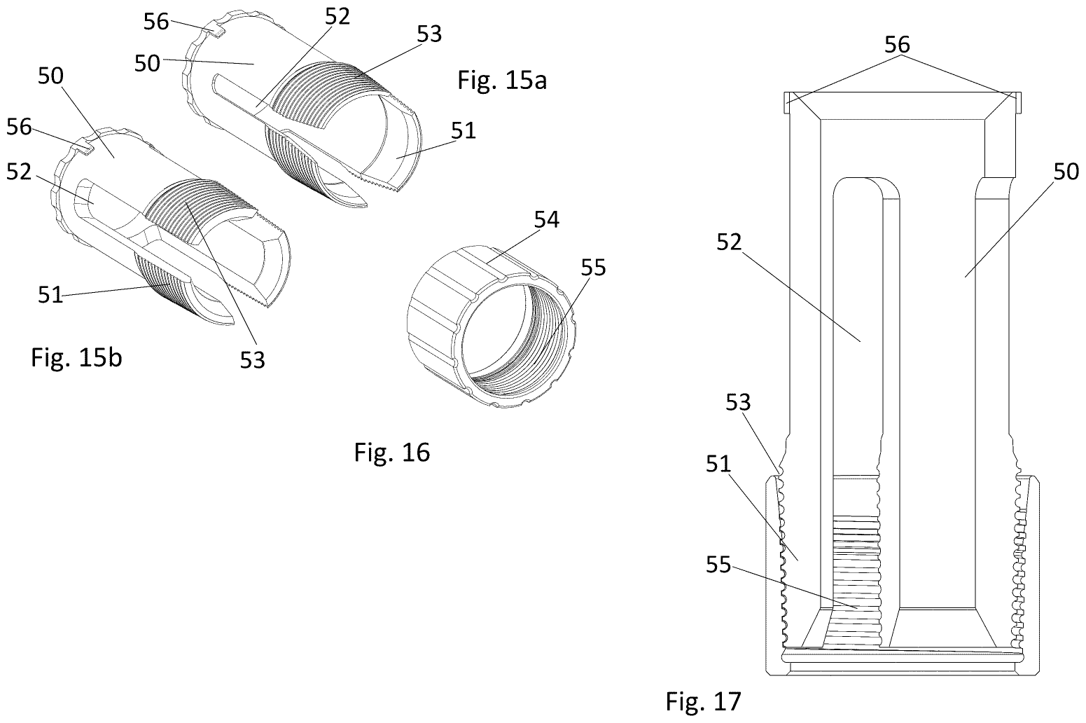

FIGS. 15a and 15b show two different sleeves 50 according to the invention. These have several slots 52 and an external thread 53 at each of their ends 51. The external dimensions of the sleeves 50 are identical, but the internal diameter is different. This means that shooting tools with different external diameters can be inserted into the different sleeves.

FIG. 16 shows a clamping nut 54 which has an internal thread 55 which fits onto the external thread 53 of each of the two sleeves 50 from FIGS. 15a and 15b. The internal thread 55 of the clamping nut 54 is conical.

If the clamping nut 54 is screwed onto a sleeve 50, the conical internal thread 55 of the clamping nut 54 presses the sleeve 50 together, which can be tapered thanks to the slots 52, and can thus hold a firing tool 11 securely in the holder 41 of the carrier system 40. The interaction of the sleeve 50 and the clamping nut 54 is shown in FIG. 17. Here, the projection 56 can also be seen, which in this embodiment also serves as knurling of the sleeve 50.

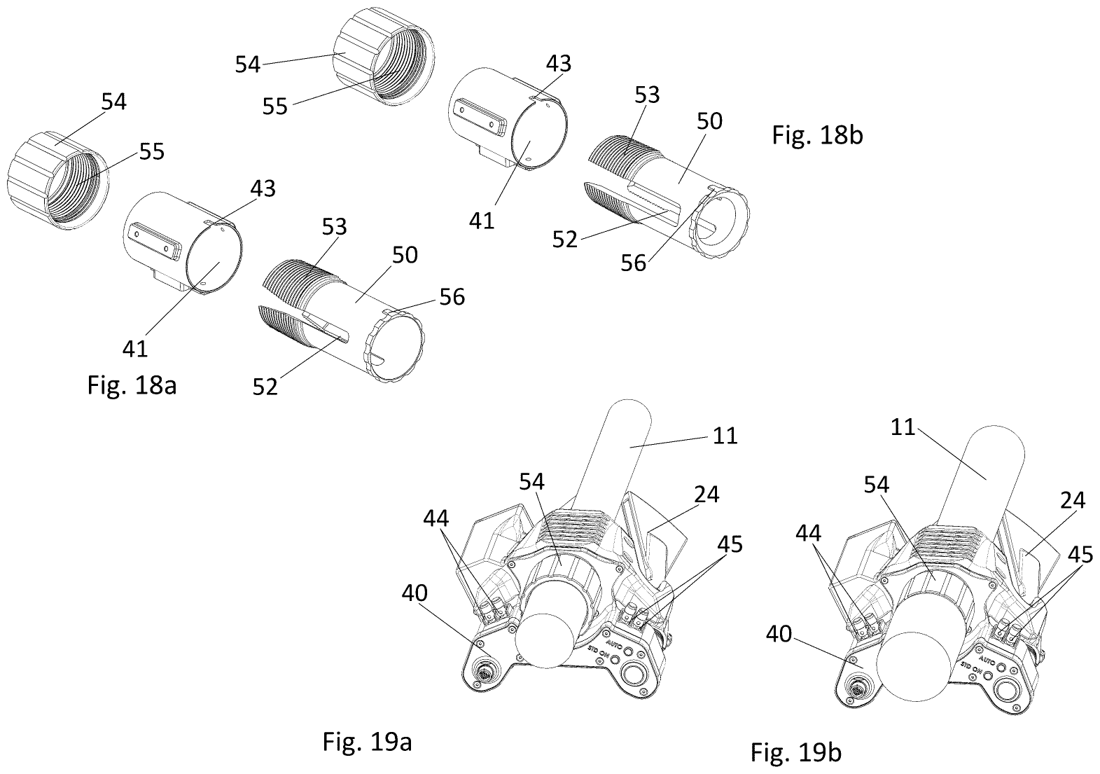

FIGS. 18a and 18b show the components clamping nut 54, sleeve 50 and holder 41 again. Here you can also see the projection 56 on the sleeve 50, which engages in the recess 43 on the holder 41 so that the sleeve 50 is held in the holder 41 in a rotationally secure manner and does not rotate when the clamping nut 54 is screwed on.

In FIGS. 19a and 19b you can see how firing tools 11 with different outer diameters and different lengths are arranged on the same carrier system 40. You can see the clamping nuts 54 that hold the sleeves 50 arranged in the receptacles 41 of the carrier systems 40. The sleeves 50 cannot be seen here, but are hidden by the overall geometry of the device.

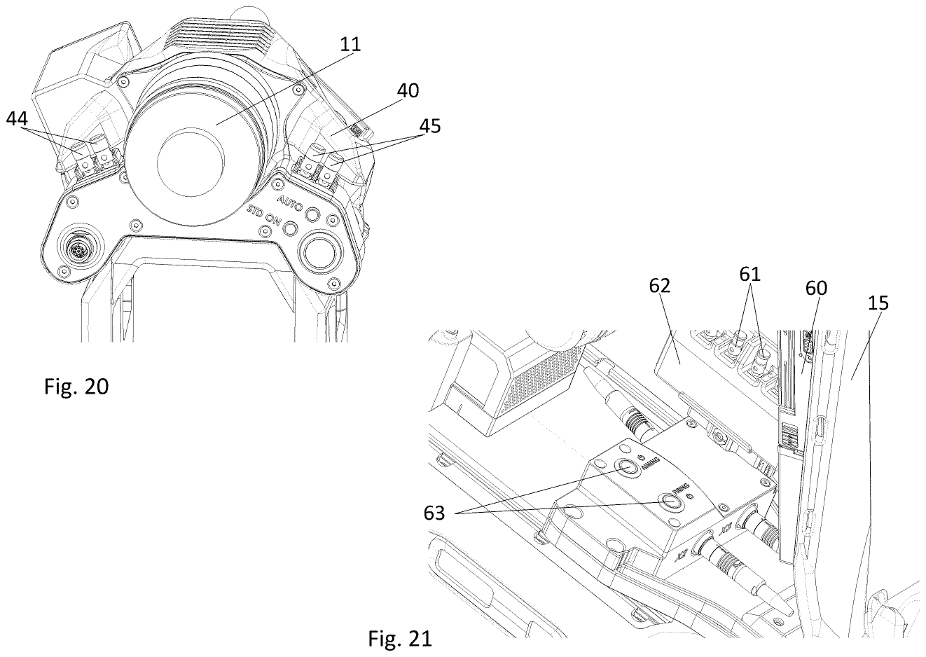

In FIG. 20 you can see the carrier system 40 with the firing tool 11. Here you can see the first electrical connection means 44 and the second electrical connection means 45. The first electrical connection means 44 and the second electrical connection means 45 are electrically connected to one another within the carrier system 40 and pass on the ignition signal received by the receiver 60 and transmitted to the ignition unit 62. Cables are then connected to the second electrical connection means 45, which pass on the ignition pulse to the firing tool 11. However, this cable is relatively short, for example 10 cm to 20 cm, and is not directly connected to the ignition unit 62, so that it is not damaged if the cable breaks. The ignition unit 62 with the two electrical connecting means 61 arranged on it is shown in FIG. 21. Here you can also see buttons 63 with which the target system and the ignition system can be manually switched on and off.

Finally, it should be noted that the embodiments shown here are merely exemplary embodiments of the invention. This is not limited to this. Rather, modifications and variations are still possible. For example, more than two line lasers can be provided for target detection, or the lasers can emit the light in a different shape and the target point can also be arranged in a different shape rather than a cross. The display can be arranged on the device or near the device or can also be spaced apart from the device. The carrier system can be gripped independently by the gripping unit of the robot. For this purpose, it can be arranged in a device on the robot itself or near the robot or the bomb to be defused. It is also possible for the robot to put down the carrier system located in the gripping unit, for example to use the gripping unit to open a door or to carry out another movement or another activity, and then pick up the carrier system again. One or more line lasers can also be used for the targeting device.

### LIST OF REFERENCE SYMBOLS

10 Device
11 Firing tool
12 Camera
13 Robot
14 Gripping unit of 13
15 Boundary geometry component
20.1 Target laser
20.2 Target laser
21.1 Projection plane of 20.1
21.2 Projection plane of 20.2
22 Crossing line
23 Alignment aid
24 Light shaft
30 Distance measuring device
31 Laser
40 Carrier system
41 Receptacle
42 Display
43 Recess
44 First electrical connection means
45 Second electrical connection means
46 Area at 40
50 Sleeve
51 One end of 50
52 Slot
53 External thread at 50
54 Clamping nut
55 Internal thread at 54
56 Projection
60 Receiver
61 Electrical connection means at 62
62 Ignition unit
63 Button

1. A system comprising a robot (13) and at least one device (10) for the targeted alignment of firing tools (11) with a firing axis on a target to be hit
with at least one carrier system (40) for a firing tool (11), which comprises a targeting device and has at least one receptacle (41) into which the firing tool (11) can be inserted in certain areas,
characterized in that
a plurality of differently shaped firing tools (11) can be inserted into the receptacle (41) and secured there.

2. The system according to claim 1, characterized in that at least one sleeve (50) is provided which can be inserted into the receptacle (41) on the carrier system (40) and secured there.

3. The system according to claim 2, characterized in that the sleeve (50) has at least one slot (52) along its longitudinal direction at one end (51) and comprises an external thread (53) which also extends in the region of the slot(s) (52)
and that a clamping nut (54) is provided which comprises an internal thread (55) and which can be screwed onto the external thread (53) on the sleeve (50).

4. The system according to claim 3, characterized in that the external thread (53) of the sleeve (50) and/or the internal thread (55) of the clamping nut (54) is conical or otherwise progressively tapered.

5. The system according to claim 2, characterized in that the sleeve (50) has a projection (56) and the receptacle (41) comprises a recess (43), which can interact with one another in such a way that the sleeve (50) can be held in the receptacle (41) in a rotationally secure manner.

6. The system according to claim 1, characterized in that an area (46) of the carrier system (40) can be gripped by a gripping unit (14) located on the robot (13) in order to fix the firing tool (11) on the robot (13).

7. The system according to claim 6, characterized in that at least one camera (12) is provided on the robot (13), which is not covered by the carrier system (40) or the gripping unit (14) even when the carrier system (40) is gripped by the gripping unit (14).

8. The system according to claim 1, characterized in that the aiming device has at least two aiming lasers (20.1, 20.2) designed as line lasers, the projection planes (21.1, 21.2) of which are arranged at an angle other than 180° around the firing axis and which intersect and thereby form an intersection line that is identical to the firing axis and which also has a target point that is defined by the projection of the intersection line onto the target to be hit when the light of the aiming lasers (20.1, 20.2) hits the target.

9. The system according to claim 1, characterized in that a separate distance measuring device (30) is provided, which measures the distance of the device (10) to the target to be hit by means of at least one laser (31) and/or another suitable distance measuring device.

10. The system according to claim 8, characterized in that a light shaft (24) is provided for each of the target lasers (20.1, 20.2), which simulates the fan of the beams and encloses them, so that the beam cross section of the respective target laser (20.1, 20.2) is further fanned out at the radiation exit.

11. The system according to claim 1, characterized in that a boundary geometry component (15) is provided, which serves to protect the surrounding components and/or the robot (13) from damage, in particular through the use of the firing tool (11).

12. The system according claim 1, characterized in that the device (10) has one or more alignment aids (23) which serve to align the target lasers (20.1, 20.2) and their projection planes (21.1, 21.2) to the firing axis or the alignment of the firing tool (11).

13. The system according to claim 1, characterized in that several firing tools (11) are provided on the robot (13) and the specific firing tool (11) is selected depending on the measured distance of the device (10) to the target and/or the nature of the target.

14. The system according to claim 1, characterized in that the targeting device and/or the firing tool (11) or its ignition unit (62) can be switched on and/or off manually.

15. The system according to claim 1, characterized in that the communication with the robot (13) and/or the ignition unit (62) of the firing tool (11) and/or the targeting device takes place by means of radio, WLAN, Bluetooth, infrared, a mobile network or another wireless data connection and that a single wireless data connection is used for the communication and/or the control of the robot (13), the control of the targeting device and/or the ignition unit (62) for the ignition of the firing tool (11).

16. The system according to claim 1, characterized in that the firing tool (11) can be remotely ignited and a receiver (60) for receiving the ignition signal is arranged on the robot (13), whereby from the receiver (60) via the ignition unit (62), with the interposition of electrical connection means (61) on the ignition unit (62), cables which pass the ignition pulse to the firing tool (11) are fed into the carrier system (40) via first electrical connection means (44) and are passed on there to second electrical connection means (45) within the carrier system (40), whereby the second electrical connection means (45) are arranged close to the firing tool (11).
